(19) United States
(12) Patent Application Publication
(10) Pub. No.: US 2026/0195720 A1
(43) Pub. Date: Jul. 9, 2026

(54) INFORMATION PROCESSING SYSTEM, METHOD, PROGRAM, STORAGE MEDIUM, AND INFORMATION PROCESSING DEVICE

(71) Applicant: DENTSU INC., Tokyo (JP)

(72) Inventors: Mihoko HOTTA, Tokyo (JP); Hiroyuki KURASAWA, Tokyo (JP); Yoshihiro OOTAKI, Tokyo (JP); Maya TSUDA, Tokyo (JP); Yuutaro ONO, Tokyo (JP); Yuu SANADA, Tokyo (JP); Akito TAKAHAMA, Tokyo (JP); Tenpei ISHII, Tokyo (JP)

(73) Assignee: DENTSU INC., Tokyo (JP)

(21) Appl. No.: 19/130,065

(22) PCT Filed: Nov. 17, 2023
(86) PCT No.: PCT/JP2023/041391

§ 371 Date: May 14, 2025

(30) Foreign Application Priority Data
Dec. 22, 2022 (JP) 2022-205475

(51) Int. Cl. G06Q 10/30

(52) U.S. Cl. CPC G06Q 10/30

(57) ABSTRACT

An information processing system includes: a product information acquirer that acquires product information of a product from a terminal device of a manufacturer; a sales information acquirer that acquires sales information of the product from a terminal device of a distributor; a consumer information acquirer that acquires consumer information from a terminal device of a consumer; a collection information acquirer that acquires collection information of the product from the terminal device of the consumer; a recycling information acquirer that acquires recycling information of the product from the terminal device of the recycler; and a statistical information generation unit that generates statistical information regarding a statistic calculated by using the consumer information and at least one of the product information, the sales information, the collection information, and the recycling information.

### TECHNICAL FIELD

The present invention relates to an information processing system, a method, a program, a storage medium, and an information processing device.

### BACKGROUND ART

Conventionally, a technique capable of managing an overall life cycle of a flow from production to disposal or recycling of a product, and streamlining determinations and processing procedures in a case where the product or a component thereof is recycled or discarded is known (see Patent Literature 1).

### CITATION LIST

### Patent Literature

Patent Literature 1: JP 2000-48066 A

### SUMMARY OF INVENTION

### Technical Problem

However, there has been no proposal to analyze information in consideration of information of consumers involved in a product life cycle in a circular economy.

An object to be achieved by the present invention is to generate information contributing to improvement in efficiency of product recycling in a circular economy by using a plurality of pieces of information including consumer information.

### Solution to Problem

An information processing system according to a first aspect includes a terminal device of a manufacturer that produces a product, a terminal device of a distributor who purchases the product from the manufacturer and sells the product, a terminal device of a consumer who purchases the product from the distributor and uses the product, a terminal device of a recycler who collects and recycles the used product from the consumer, and a server accessible by each device. The information processing system includes a product information acquirer that acquires product information of the product from the terminal device of the manufacturer, a sales information acquirer that acquires sales information of the product from the terminal device of the distributor, a consumer information acquirer that acquires consumer information from the terminal device of the consumer, a collection information acquirer that acquires collection information of the product from the terminal device of the consumer, a recycling information acquirer that acquires recycling information of the product from the terminal device of the recycler, and a statistical information generation unit that generates statistical information regarding a statistic calculated by using the consumer information and at least one of the product information, the sales information, the collection information, and the recycling information.

According to the above aspect, it is possible to generate information contributing to improvement in efficiency of product recycling in the circular economy by using a plurality of pieces of information including the consumer information.

In an information processing system according to a second aspect in the information processing system according to the first aspect, the consumer information includes information regarding at least one of an age, a sex, a residence, an occupation, a product collection history, and a preference of the consumer.

According to the above configuration, since the information regarding at least one of the age, the sex, the residence, the occupation, the product collection history, and the preference of the consumer as the consumer information is used to generate the statistic, it is possible to generate the information contributing to the improvement in efficiency of product recycling in the circular economy.

In an information processing system according to a third aspect in the information processing system according to the first or second aspect, the collection information includes information regarding a collection place of the product and information regarding a collection amount of the product for each collection place.

According to the above configuration, since the collection information including the information regarding the collection place of the product and the information regarding the collection amount of the product for each collection place is used to generate the statistic, it is possible to generate information contributing to improvement in efficiency of product recycling in the circular economy.

In an information processing system according to a fourth aspect in the information processing system according to the third aspect, the statistical information generation unit generates statistical information regarding a statistic obtained by aggregating the collection amount for each collection place, and the information processing system further comprises an output unit that outputs information obtained by visualizing the statistical information generated by the statistical information generation unit.

According to the above configuration, since the information obtained by visualizing the statistical information regarding the statistic obtained by aggregating the collection amount for each collection place is output, it is possible to generate information contributing to improvement in efficiency of product recycling in the circular economy.

In an information processing system according to a fifth aspect in the information processing system according to the third or fourth aspect, the product information includes first time information regarding a shipment date and time of the product, the collection information includes second time information regarding a date and time when the product is placed at the collection place by the consumer, and the statistical information generation unit generates statistical information regarding a difference between the first time information and the second time information for each collection place.

According to the above configuration, since the statistical information regarding the difference between the first time information and the second time information is generated for each collection place, the collector or the recycler uses the statistical information as information regarding a collection term for each collection place, whereby it is possible to smoothly collect products.

In an information processing system according to a sixth aspect in the information processing system according to any one of the first to fifth aspects, the product information includes information regarding a production amount of the product,
the sales information includes information regarding a retail amount of the product, and the statistical information generation unit generates statistical information regarding a statistic obtained by dividing the retail amount by the production amount.

According to the above configuration, since the statistical information generation unit generates the statistical information regarding the statistic obtained by dividing the sales amount by the production amount, it is possible to use the statistical information as an index for controlling the amount of products circulating in the circular economy. As a result, it is possible to improve efficiency of recycling products by suppressing excessive distribution of products.

In an information processing system according to a seventh aspect in the information processing system according to any one of the first to sixth aspects, the product information includes information regarding a production amount of the product,
the collection information includes information regarding a collection amount of the product, and the statistical information generation unit generates statistical information regarding a statistic obtained by dividing the collection amount by the production amount.

According to the above configuration, since the statistical information generation unit generates the statistical information regarding a statistic obtained by dividing the collection amount by the production amount, it is possible to use the statistical information for the life cycle assessment.

In an information processing system according to an eighth aspect in the information processing system according to any one of the first to seventh aspects, the product information includes information regarding a production amount of the product,
the recycling information includes information regarding a recycling amount indicating an amount of the product recycled after collection, and the statistical information generation unit generates statistical information regarding a statistic obtained by dividing the recycling amount by the production amount.

According to the above configuration, it is possible to generate the statistical information regarding the statistic obtained by dividing the recycling amount by the production amount, as the information contributing to the improvement in the efficiency of recycling.

In an information processing system according to a ninth aspect in the information processing system according to any one of the first to eighth aspects, the product information includes information regarding a production amount of the product, the collection information includes information regarding a collection amount of the product, the recycling information includes information regarding a resource-recycled amount indicating an amount resource-recycled among products recycled after collection, and the statistical information generation unit generates statistical information regarding a statistic obtained by dividing the resource-recycled amount by the collection amount and further dividing the resource-recycled amount by the production amount.

According to the above configuration, it is possible to generate the statistical information regarding the statistic obtained by dividing the resource-recycled amount by the collection amount and further dividing the resource-recycled amount by the production amount, as the information contributing to the improvement in the efficiency of recycling.

In an information processing system according to a tenth aspect in the information processing system according to any one of the first to ninth aspects, the product information includes information regarding a production amount of the product and information regarding a wholesale amount of the product, the sales information includes information regarding a retail amount of the product, the collection information includes information regarding a collection amount of the product, the recycling information includes information regarding a recycling amount indicating an amount of the product recycled after collection, and the statistical information generation unit generates statistical information regarding a statistic obtained by subtracting the wholesale amount, the retail amount, the collection amount, and the recycling amount from the production amount.

According to the above configuration, it is possible to generate the statistical information regarding the statistic obtained by subtracting the wholesale amount, the retail amount, the collection amount, and the recycling amount from the production amount, as the information contributing to improvement in efficiency of recycling.

In an information processing system according to an eleventh aspect in the information processing system according to any one of the first to tenth aspects, the product information includes information regarding an amount of reduction in carbon dioxide emission per product reduced by recycling the product, the recycling information includes information regarding a recycling amount indicating an amount of the product recycled after collection, and the statistical information generation unit generates statistical information regarding a statistic obtained by multiplying the recycling amount by the amount of reduction in carbon dioxide emission per product.

According to the above configuration, it is possible to generate the statistical information regarding the statistic obtained by multiplying the recycling amount by the amount of reduction in carbon dioxide emission per product, as the information contributing to improvement in the efficiency of recycling.

An information processing system according to a twelfth aspect in the information processing system according to any one of the first to eleventh aspects further includes a display controller that displays information regarding traceability of the product or a component of the product on a display unit of at least one device of the respective devices.

According to the above configuration, a manufacturer, a distributor, a consumer, or a recycler who uses the information processing system can easily check information regarding traceability of a product or a component of the product.

A method according to a thirteenth aspect is a method using an information processing system including a terminal device of a manufacturer that produces a product, a terminal device of a distributor who purchases the product from the manufacturer and sells the product, a terminal device of a consumer who purchases the product from the distributor and uses the product, a terminal device of a recycler who collects and recycles the used product from the consumer, and a server accessible by each device. The method includes a step of acquiring product information of the product from the terminal device of the manufacturer, a step of acquiring sales information of the product from the terminal device of the distributor, a step of acquiring consumer information from the terminal device of the consumer, a step of acquiring collection information of the product from the terminal device of the consumer, a step of acquiring recycling information of the product from the terminal device of the recycler, and a step of generating statistical information regarding a statistic calculated by using the consumer information and at least one of the product information, the sales information, the collection information, and the recycling information.

According to the above configuration, it is possible to generate information contributing to improvement in efficiency of product recycling in the circular economy by using a plurality of pieces of information including the consumer information

A program according to a fourteenth aspect is a program for causing a computer to execute the method according to the thirteenth aspect.

According to the above configuration, it is possible to provide a program capable of generating information contributing to improvement in efficiency of product recycling in the circular economy by using a plurality of pieces of information including the consumer information.

A storage medium according to a fifteenth aspect is a computer-readable storage medium storing the program according to the fourteenth aspect.

According to the above configuration, it is possible to provide a storage medium storing the program capable of generating information contributing to improvement in efficiency of product recycling in the circular economy by using a plurality of pieces of information including the consumer information.

An information processing device according to a sixteenth aspect includes a product information acquirer that acquires product information of a product from a terminal device of a manufacturer that produces the product, a sales information acquirer that acquires sales information of the product from a terminal device of a distributor who purchases the product from the manufacturer and sells the product, a consumer information acquirer that acquires consumer information from a terminal device of a consumer who purchases the product from the distributor and uses the product, a collection information acquirer that acquires collection information of the product from the terminal device of the consumer, a recycling information acquirer that acquires recycling information of the product from a terminal device of a recycler who collects the used product from the consumer and recycles the product, and a statistical information generation unit that generates statistical information regarding a statistic calculated by using the consumer information and at least one of the product information, the sales information, the collection information, and the recycling information.

According to the above configuration, it is possible to generate information contributing to improvement in efficiency of product recycling in the circular economy by using a plurality of pieces of information including the consumer information.

### BRIEF DESCRIPTION OF DRAWINGS

FIG. 1 is a diagram illustrating an example of a system configuration of an information processing system according to the present embodiment.

FIG. 2 is a block diagram illustrating an example of a hardware configuration of a manufacturer terminal and a server according to the present embodiment.

FIG. 3 is a block diagram illustrating an example of a hardware configuration of a consumer terminal according to the present embodiment.

FIG. 4 is a block diagram illustrating an example of a functional configuration of the information processing system according to the present embodiment.

FIG. 5 is a block diagram illustrating an example of a database stored in a storage unit of the server in the information processing system according to the present embodiment.

FIG. 6 is a flowchart illustrating an example of an operation of the information processing system according to the present embodiment.

### DESCRIPTION OF EMBODIMENTS

Hereinafter, embodiments of the present invention will be described in detail with reference to the accompanying drawings. Note that, in the respective drawings, constituent components having equivalent functions are denoted by the same reference signs, and detailed description of the constituent components having the same reference signs will not be repeated.

### (Configuration of Information Processing System)

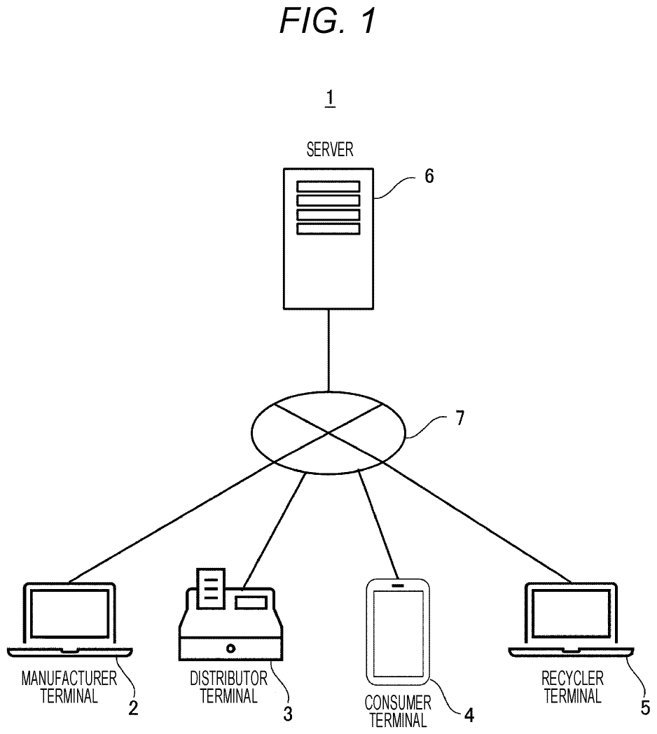

FIG. 1 is a diagram illustrating a schematic configuration of an information processing system 1 according to the present embodiment. As illustrated in FIG. 1, the information processing system 1 according to the present embodiment includes a manufacturer terminal 2 that is a terminal device of a manufacturer that manufactures a product, a distributor terminal 3 that is a terminal device of a distributor who purchases a product from the manufacturer and sells the product, a consumer terminal 4 that is a terminal device of a consumer who purchases a product from the distributor and uses the product, a recycler terminal 5 that is a terminal device of a recycler who collects and recycles a used product from the consumer, and a server 6 accessible by each device. The terminals and the server 6 are communicably connected to each other via a network 7 such as the Internet. The network 7 may be either a wired line or a wireless line, and the type and form of the line are not limited. At least a part of each terminal and the server 6 is realized by a computer (information processing device). Each terminal is used by a user of the information processing system 1, and is, for example, a mobile terminal such as a personal computer, a smartphone, or a tablet terminal. It is assumed that there are a large number of terminals in accordance with the number of users who use the information processing system 1.

### (Hardware Configuration)

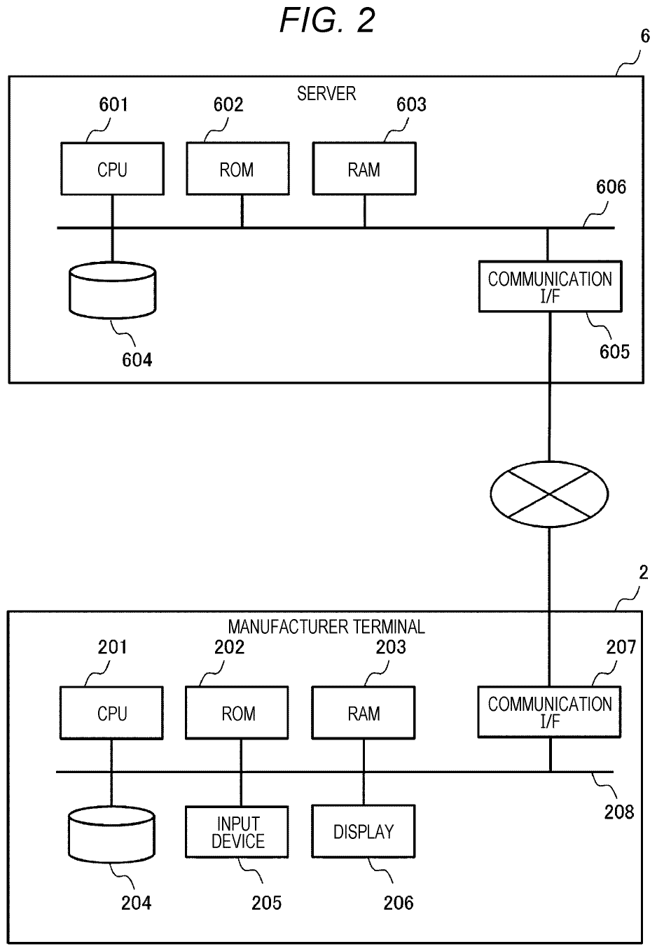

Next, a hardware configuration of the information processing system 1 according to the present embodiment will be described. FIG. 2 is a block diagram illustrating an example of the hardware configuration of the information processing system 1 according to the present embodiment, and is a diagram illustrating an example of a hardware configuration of the manufacturer terminal 2 and the server 6. Note that hardware configurations of the distributor terminal 3 and the recycler terminal 5 are similar to that of the manufacturer terminal 2, and thus the description thereof will be omitted.

In the manufacturer terminal 2, a CPU 201 is a processing device that controls the overall operation of the manufacturer terminal 2. A ROM 202 is a non-volatile memory that stores a control program executed by the CPU 201 and various types of data. A RAM 203 is a volatile memory used for a load area and a work area of a program executed by the CPU 201. A storage device 204 is storage means for storing various types of information, and may be built into the body of the manufacturer terminal 2 or a storage medium may be attachable and detachable to and from the storage device 204. An input device 205 is a device for the user of the manufacturer terminal 2 to input information, and is, for example, a touch panel, a microphone, or the like. A display 206 is a display device that displays various types of information (user interface and the like). A communication interface (I/F) 207 is an interface for connection with the server 6. A bus 208 is a bus line that connects the above constituent components to each other.

In the server 6, a CPU 601 is a processing device that controls the overall operation of the server 6. A ROM 602 is a non-volatile memory that stores a control program executed by the CPU 601 and various types of data. A RAM 603 is a volatile memory used for a load area and a work area of a program executed by the CPU 601. A storage device 604 is storage means for storing various types of information, and may be built into the body of the server 6 or a storage medium may be attachable and detachable to and from the storage device 604. A communication interface (I/F) 605 is an interface for connection with the server 6. A bus 606 is a bus line that connects the above constituent components to each other.

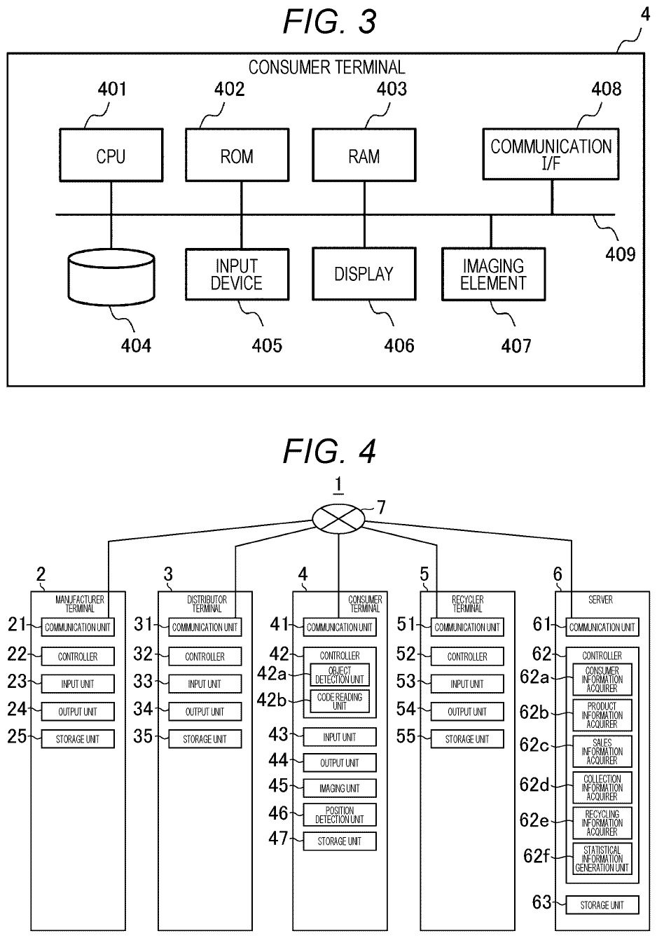

Next, a hardware configuration of the consumer terminal 4 according to the present embodiment will be described. FIG. 3 is a diagram illustrating an example of the hardware configuration of the consumer terminal 4 according to the present embodiment.

In the consumer terminal 4, a CPU 401 is a processing device that controls the overall operation of the consumer terminal 4. A ROM 402 is a non-volatile memory that stores a control program executed by the CPU 401 and various types of data. A RAM 403 is a volatile memory used for a load area and a work area of a program executed by the CPU 401. A storage device 404 is storage means for storing various types of information, and may be built into the body of the consumer terminal 4 or a storage medium may be attachable and detachable to and from the storage device 404. An input device 405 is a device for a user of the consumer terminal 4 to input information, and is, for example, a touch panel, a microphone, or the like. A display 406 is a display device that displays various types of information (user interface and the like). An imaging element 407 is a photoelectric conversion element that captures an image of a subject. A communication interface (I/F) 408 is an interface for connection with the server 6. A bus 409 is a bus line that connects the above constituent components to each other.

### (Functional Configuration)

Next, a functional configuration of the information processing system 1 according to the present embodiment will be described. FIG. 4 is a diagram illustrating an example of the functional configuration of the information processing system 1 according to the present embodiment.

First, a functional configuration of the manufacturer terminal 2 will be described. As illustrated in FIG. 4, the manufacturer terminal 2 includes a communication unit 21 that connects the manufacturer terminal 2 to the network 7, a controller 22 that controls the overall operation of the manufacturer terminal 2, an input unit 23 to which the user of the manufacturer terminal 2 inputs various types of information, an output unit 24 that outputs various types of information from a display, a speaker, or the like (not illustrated), and a storage unit 25 that stores various types of information.

The communication unit 21 is a communication interface between the manufacturer terminal 2 and the network 7. The communication unit 21 transmits and receives information between the manufacturer terminal 2 and the server 6 via the network 7.

The input unit 23 is an element for the user of the manufacturer terminal 2 to input information, and is, for example, a touch panel, a microphone, or the like. The user of the manufacturer terminal 2 inputs data such as product information via the input unit 23. Examples of the product information include product identification information (for example, JAN code), a product name, material information of a product or a component constituting the product, identification information (number, name, symbol, figure, pattern, color, and the like) of a collection box corresponding to the material information, information regarding life cycle assessment (LCA) such as a production amount, a wholesale amount, and an amount of reduction in carbon dioxide (CO₂) emission due to product recycling, information regarding product characteristics such as a product structure, a component removal method, a component replacement method, a product or component repair method, and a product instruction manual, and the like. The input product information is transmitted to the server 6 via the network 7 by the communication unit 21.

The output unit 24 is an interface that outputs various types of information to the user of the manufacturer terminal 2, and is, for example, a video display device (display unit) such as a liquid crystal display or an audio output device such as a speaker. The output unit 24 may output (display) a graphical user interface (GUI) for receiving an operation from the user.

The storage unit 25 is, for example, a data storage such as a built-in memory or an external memory (SD memory card or the like). The storage unit 25 stores various types of data handled by the controller 22, various types of information downloaded by the communication unit 21 from the server 6 via the network 7, and the like. Note that the storage unit 25 is not necessarily provided in the manufacturer terminal 2, and a part or the entirety of the storage unit 25 may be provided in another device communicably connected to the manufacturer terminal 2 via the network 7.

Next, a functional configuration of the distributor terminal 3 will be described. The distributor terminal 3 includes a communication unit 31 that connects the distributor terminal 3 to the network 7, a controller 32 that controls the overall operation of the distributor terminal 3, an input unit 33 to which a user of the distributor terminal 3 inputs various types of information, an output unit 34 that outputs various types of information from a display, a speaker, or the like (not illustrated), and a storage unit 35 that stores various types of information.

The communication unit 31 is a communication interface between the distributor terminal 3 and the network 7. The communication unit 21 transmits and receives information between the distributor terminal 3 and the server 6 via the network 7.

The input unit 33 is an element for the user of the distributor terminal 3 to input information, and is, for example, a touch panel, a microphone, or the like. The user of the distributor terminal 3 inputs data such as sales information via the input unit 33. Examples of the sales information include a name of a sold product, product identification information (JAN code or the like), a date and time of sale of the product, a sales price, the number of sold products, attributes (user ID (identification information), an age, a date of birth, a sex, a residence (administrative district information), occupation, and the like) of a purchaser (consumer), electronic money, points and coupons used by the purchaser (consumer), a store name, and position information such as an address, longitude, and latitude of a store. The input sales information is transmitted to the server 6 via the network 7 by the communication unit 31.

The output unit 34 is an interface that outputs various types of information to the user of the distributor terminal 3, and is, for example, a video display device (display unit) such as a liquid crystal display or an audio output device such as a speaker. The output unit 34 may output (display) a graphical user interface (GUI) for receiving an operation from the user.

The storage unit 35 is, for example, a data storage such as a built-in memory or an external memory (SD memory card or the like). The storage unit 35 stores various types of data handled by the controller 32, various types of information downloaded by the communication unit 31 from the server 6 via the network 7, and the like. Note that the storage unit 35 is not necessarily provided in the manufacturer terminal 2, and a part or the entirety of the storage unit 35 may be provided in another device communicably connected to the distributor terminal 3 via the network 7.

Next, a functional configuration of the consumer terminal 4 will be described. The consumer terminal 4 includes a communication unit 41, a controller 42 that controls the overall operation of the consumer terminal 4, an input unit 43 to which a user inputs various types of information, an output unit 44 that outputs various types of information, an imaging unit 45 that captures an image of a subject, a position detection unit 46 that detects a current position of the consumer terminal 4, and a storage unit 47 that stores various types of information.

The communication unit 41 is a communication interface between the consumer terminal 4 and the network 7. The communication unit 41 transmits and receives information between the consumer terminal 4 and the server 6 via the network 7.

The controller 42 includes an object detection unit 42a and a code reading unit 42b.

The object detection unit 42a detects an object from an image captured by the imaging unit 45. For example, the object detection unit 42a detects a product to be collected from an image captured by the imaging unit 45. Any algorithm may be used for object detection. For example, an identifier combining image features such as HoG or Haar-like and boosting may be used, or human body recognition by deep learning such as R-CNN, Fast R-CNN, YOLO, or SSD may be used. In a case where the object detection unit 42a detects a product to be collected, image information of the product is transmitted as product identification information to the server 6 via the network 7 by the communication unit 41.

The code reading unit 42b reads a code from an image captured by the imaging unit 45. For example, the code reading unit 42b reads a product code (for example, JAN code) from an image of a product captured by the imaging unit 45. The product code read by the code reading unit 42b is transmitted as product identification information to the server 6 via the network 7 by the communication unit 41.

The input unit 43 is an element for the user of the consumer terminal 4 to input information, and is, for example, a touch panel, a microphone, or the like. The user of the consumer terminal 4 inputs data such as consumer information and collection information via the input unit 43. Examples of the consumer information include user account information such as an user ID (identification information), an age, a date of birth, a sex, a residence (prefecture information), an occupation, and a preference, a collection history, the number of acquired points and an acquisition date and time, the number of possessed points, the cumulative number of acquired points, the number of used points and a date and time, possessed coupons, the number of used coupons and a date and time, distributed advertisement information, browsed advertisement information (information regarding an advertisement whose details have been confirmed by a user tapping/clicking on the advertisement among distributed advertisements), the number of browsed advertisements (the number of times of the user tapping/clicking the advertisement), and the like. Examples of the collection information include an attribute of a user of a collected product (age, date of birth, sex, residence, occupation, preference, and the like), product identification information (for example, JAN code), a product name, material information of the product or a component of the product, the number of products collected, a date and time when the product was placed in a collection place (a date and time when the product was inserted into the collection box), and a collection place (collection store). The input consumer information and collection information are transmitted to the server 6 by the communication unit 41 via the network 7.

The output unit 44 is an interface that outputs various types of information to the user of the consumer terminal 4, and is, for example, a video display device (display unit) such as a liquid crystal display or an audio output device such as a speaker. The output unit 44 may output (display) a graphical user interface (GUI) for receiving an operation from the user.

The imaging unit 45 captures an image of a subject by a camera module including an imaging element of the consumer terminal 4. The image captured by the imaging unit 45 is output to the controller 42, subjected to various types of image processing, and then output by the output unit 44.

The position detection unit 46 detects the current position (position information) of the consumer terminal 4. For example, the position detection unit 46 detects the position information of the consumer terminal 4 by using a global positioning system (GPS), Wi-Fi (registered trademark), a cell ID (CID), an RFID, or the like.

The storage unit 47 is, for example, a data storage such as a built-in memory or an external memory (SD memory card or the like). The storage unit 47 stores various types of data handled by the controller 42, various types of information downloaded by the communication unit 41 from the server 6 via the network 7, images captured by the imaging unit 45, and the like. Note that the storage unit 47 is not necessarily provided in the consumer terminal 4, and a part or the entirety of the storage unit 47 may be provided in another device communicably connected to the consumer terminal 4 via the network 7.

Next, a functional configuration of the recycler terminal 5 will be described. The recycler terminal 5 includes a communication unit 51 that connects the recycler terminal 5 to the network 7, a controller 52 that controls the overall operation of the recycler terminal 5, an input unit 53 to which a user of the recycler terminal 5 inputs various types of information, an output unit 54 that outputs various types of information from a display, a speaker, or the like (not illustrated), and a storage unit 55 that stores various types of information.

The communication unit 51 is a communication interface between the recycler terminal 5 and the network 7. The communication unit 51 transmits and receives information between the recycler terminal 5 and the server 6 via the network 7.

The input unit 53 is an element for the user of the recycler terminal 5 to input information, and is, for example, a touch panel, a microphone, or the like. The user of the recycler terminal 5 inputs data such as recycling information via the input unit 53. Examples of the recycling information include information such as a name of a recycled product, a collected material and an amount thereof, a collection place (area), a collection date and time, information regarding resource-recycling, an amount of a recycled material, and the like. The input recycling information is transmitted to the server 6 via the network 7 by the communication unit 51.

The output unit 54 is an interface that outputs various types of information to the user of the recycler terminal 5, and is, for example, a video display device (display unit) such as a liquid crystal display or an audio output device such as a speaker. The output unit 54 may output (display) a graphical user interface (GUI) for receiving an operation from the user.

The storage unit 55 is, for example, a data storage such as a built-in memory or an external memory (SD memory card or the like). The storage unit 55 stores various types of data handled by the controller 52, various types of information downloaded by the communication unit 51 from the server 6 via the network 7, and the like. Note that the storage unit 55 is not necessarily provided in the manufacturer terminal 2, and a part or the entirety of the storage unit 55 may be provided in another device communicably connected to the recycler terminal 5 via the network 7.

Next, a functional configuration of the server 6 will be described. As illustrated in FIG. 4, the server 6 includes a communication unit 61, a controller 62 that controls the overall operation of the server 6, and a storage unit 63 that stores various types of information.

The communication unit 61 is a communication interface between the server 6 and the network 7. The communication unit 61 transmits and receives information between the server 6 and each terminal (manufacturer terminal 2, distributor terminal 3, consumer terminal 4, and recycler terminal 5) via the network 7.

The controller 62 includes a consumer information acquirer 62a, a product information acquirer 62b, a sales information acquirer 62c, a collection information acquirer 62d, a recycling information acquirer 62e, and a statistical information generation unit 62f.

The consumer information acquirer 62a acquires consumer information input by the user of the consumer terminal 4 via the input unit 43, from the communication unit 61 via the network 7. The consumer information acquired by the consumer information acquirer 62a is stored in the storage unit 63.

The product information acquirer 62b acquires product information input by the user of the manufacturer terminal 2 via the input unit 23, from the communication unit 61 via the network 7. The product information acquired by the product information acquirer 62b is stored in the storage unit 63.

The sales information acquirer 62c acquires sales information input by the user of the distributor terminal 3 via the input unit 33, from the communication unit 61 via the network 7. The sales information acquired by the sales information acquirer 62c is stored in the storage unit 63.

The collection information acquirer 62d acquires collection information input by the user of the consumer terminal 4 via the input unit 43, from the communication unit 61 via the network 7. The collection information acquired by the collection information acquirer 62d is stored in the storage unit 63.

The recycling information acquirer 62e acquires the recycling information input by the user of the consumer terminal 4 via the input unit 43, from the communication unit 61 via the network 7. The recycling information acquired by the recycling information acquirer 62e is stored in the storage unit 63.

The storage unit 63 is, for example, a data storage such as a built-in memory or an external memory (SD memory card or the like). The storage unit 63 stores various types of data handled by the controller 62, various types of information acquired by the communication unit 61 via the network 7, and the like.

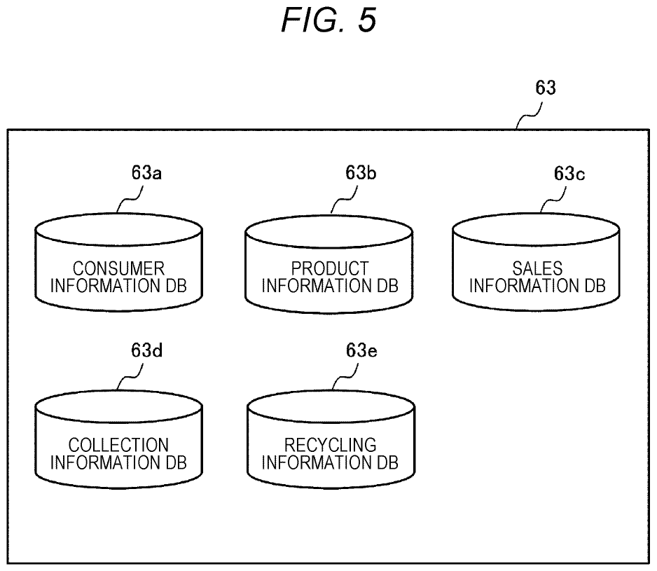

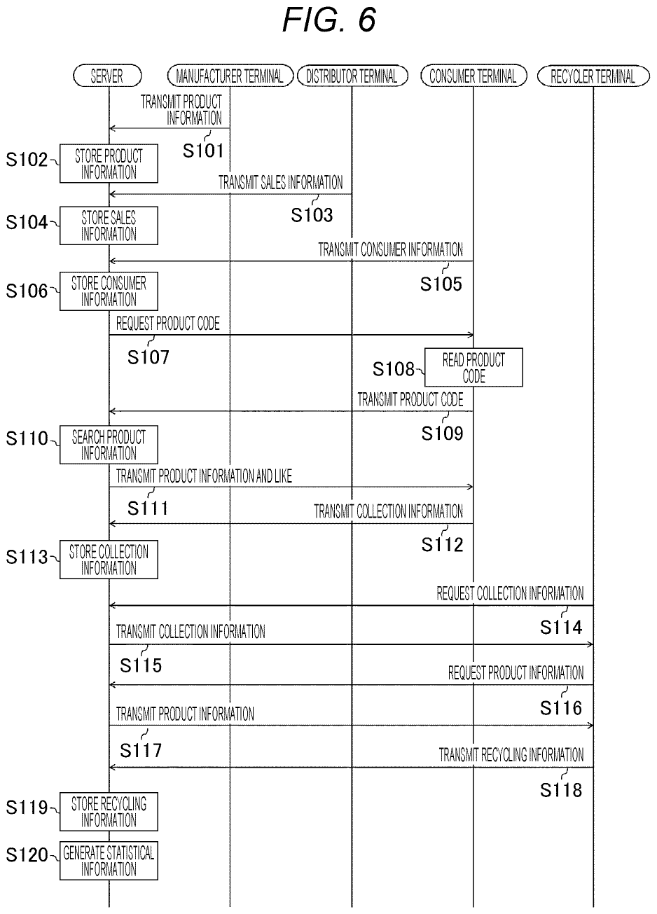

FIG. 5 is a diagram illustrating an example of a database stored in the storage unit 63 of the server 6. As illustrated in FIG. 5, the storage unit 63 includes a consumer information DB 63a including the consumer information acquired by the consumer information acquirer 62a, a product information DB 63b including the product information acquired by the product information acquirer 62b, a sales information DB 63c including the sales information acquired by the sales information acquirer 62c, a collection information DB 63d including the collection information acquired by the collection information acquirer 62d, and a recycling information DB 63e including the recycling information acquired by the recycling information acquirer 62e.

Note that the storage unit 63 is not necessarily provided in the server 6, and a part or the entirety of the storage unit 63 may be provided in another device communicably connected to the server 6 via the network 7.

Returning to FIG. 4, the statistical information generation unit 62f generates statistical information regarding a statistic calculated by using the consumer information stored in the storage unit 63 and at least one of the product information, the sales information, the collection information, and the recycling information.

Specifically, for example, the statistical information generation unit 62f may read the collection amount for each collection place from the collection information DB 63d of the storage unit 63 and generate statistical information regarding a statistic obtained by aggregating the collection amount for each collection place.

For example, the statistical information generation unit 62f may read information (first time information) regarding a shipment date and time of a product from the product information 63b in the storage unit 63, read information (second time information) regarding a date and time when the product is placed by a consumer in the collection place, from the collection information 63d, and generate statistical information regarding a difference (second time information-first time information) between the first time information and the second time information. As a result, it is possible to generate, as statistical information, information regarding the time required for a consumer to place a used product at a collection place from shipment of the product.

In addition, for example, the statistical information generation unit 62f may read information regarding the production amount of a product from the product information DB 63b in the storage unit 63, read information regarding a retail amount of the product from the sales information DB 63c, and generate statistical information regarding a statistic (retail amount/production amount) obtained by dividing the retail amount by the production amount.

In addition, for example, the statistical information generation unit 62f may read information regarding the production amount of the product and information regarding a wholesale amount of the product from the product information DB 63b in the storage unit 63, and generate statistical information regarding a statistic (wholesale amount/production amount) obtained by dividing the wholesale amount by the production amount.

In addition, for example, the statistical information generation unit 62f may read information regarding the production amount of the product from the product information DB 63b in the storage unit 63, read information regarding a collection amount of the product from the collection information DB 63d, and generate statistical information regarding a statistic (collection amount/production amount) obtained by dividing the collection amount by the production amount.

In addition, for example, the statistical information generation unit 62f may read information regarding the production amount of the product from the product information DB 63b in the storage unit 63, read information regarding a recycling amount indicating the amount of the product recycled after collection from the recycling information DB 63e, and generate statistical information regarding a statistic (recycling amount/production amount) obtained by dividing the recycling amount by the production amount.

In addition, for example, the statistical information generation unit 62f may read information regarding the production amount of the product from the product information DB 63b in the storage unit 63, read information regarding the collection amount of the product from the collection information DB 63d, read information regarding a resource-recycled amount indicating a resource-recycled amount among products recycled after collection, from the recycling information DB 63e, and generate statistical information regarding a statistic (resource-recycled amount/collection amount/production amount) obtained by dividing the resource-recycled amount by the collection amount, and further dividing the resource-recycled amount by the production amount.

In addition, for example, the statistical information generation unit 62f may read information regarding the production amount of the product and the information on the wholesale amount of the product from the product information DB 63b in the storage unit 63, read information regarding the retail amount of the product from the sales information DB 63c, read information regarding the collection amount of the product from the collection information DB 63d, read information regarding the recycling amount indicating the amount of the product recycled after collection from the recycling information DB 63e, and generate statistical information regarding a statistic (production amount-wholesale amount-retail amount-collection amount-recycling amount) obtained by subtracting the wholesale amount, the retail amount, the collection amount, and the recycling amount from the production amount. As a result, it is possible to generate statistical information regarding a circulation amount of the product in the circular economy.

In addition, for example, the statistical information generation unit 62f may read, from the product information DB 63b in the storage unit 63, information regarding an amount of reduction in carbon dioxide emission per product reduced by recycling products, read, from the recycling information DB 63e, information regarding the recycling amount indicating the amount of the product recycled after collection, and generate statistical information regarding a statistic (recycling amount×amount of reduction in CO₂ emission) obtained by multiplying the recycling amount by the amount of reduction in carbon dioxide emission per product. As a result, it is possible to generate statistical information regarding the amount of reduction in carbon dioxide emission in the entire circular economy.

Information obtained by visualizing the statistical information generated by the statistical information generation unit 62f may be output by the output unit of each terminal. For example, the output unit of each terminal may output a graph, a chart, or a map (for example, heat map) visually displayed by dividing the statistic for each of the attributes (age, sex, residence, occupation, product collection history, preference, and the like) of the consumer, the collection place, the collection store, and the collection product. As a result, the user of each terminal in the information processing system 1 can visually and easily understand the statistical information.

### Example of Operation

Next, an example of an operation of the information processing system 1 will be described. FIG. 5 is a flowchart illustrating the example of the operation of the information processing system 1.

First, in the manufacturer terminal 2, the controller 22 transmits product information input by the user of the manufacturer terminal 2 via the input unit 23 to the server 6 via the communication unit 21 (Step S101).

The server 6 that has received the product information from the manufacturer terminal 2 via the communication unit 61 stores the received product information in the product information DB 63b of the storage unit 63 (Step S102).

Then, in the distributor terminal 3 of a distributor who has purchased the product from the manufacturer, the controller 32 transmits sales information input by the user of the distributor terminal 3 via the input unit 33 to the server 6 via the communication unit 31 (Step S103).

The server 6 that has received the sales information from the distributor terminal 3 via the communication unit 61 stores the received sales information in the product information DB 63b of the storage unit 63 (Step S104).

Then, in the consumer terminal 4 of a consumer who has purchased the product from the distributor (store), the controller 42 transmits consumer information input by the user (consumer) of the consumer terminal 4 via the input unit 43 to the server 6 via the communication unit 41 (Step S105).

The controller 62 of the server 6 that has received the consumer information from the consumer terminal 4 via the communication unit 61 stores the received consumer information in the product information DB 63b of the storage unit 63 (Step S106).

The controller 62 of the server 6 transmits a request for transmission of a product code (product identification information) to the consumer terminal 4 via the communication unit 61 (Step S107).

When the consumer terminal 4 receives the request for transmission of a product code from the server 6, the controller 42 causes the output unit 44 to output information for prompting the user to read the product code. For example, a message such as “please scan JAN code” may be displayed on the display of the consumer terminal 4. The controller 42 causes the code reading unit 42b to read the product code in response to a user operation on the consumer terminal 4 (Step S108).

Then, the controller 42 of the consumer terminal 4 causes the communication unit 41 to transmit the product code read by the code reading unit 42b to the server 6 (Step S109).

The controller 62 of the server 6 that has received the product code from the consumer terminal 4 searches the product information DB 63b of the storage unit 63 for a product by using the received product code as a query (Step S110).

The controller 62 of the server 6 transmits the product information including information regarding the material of the corresponding product and identification information of the collection box to the consumer terminal 4 (Step S111).

Then, after the consumer has inserted (collected) the product into the collection box, on the consumer terminal 4, the user (consumer) of the consumer terminal 4 inputs collection information including information such as the product name, the number of pieces, and the collection place of the collection product via the input unit 43. The controller 42 of the consumer terminal 4 transmits the collection information input by the user to the server 6 (Step S112).

The server 6 that has received the collection information from the consumer terminal 4 via the communication unit 61 stores the received collection information in the collection information DB 63d of the storage unit 63 (Step S113).

The controller 52 of the recycler terminal 5 transmits a request for the collection information to the server 6 (Step S114).

The server 6 that has received the request for the collection information from the recycler terminal 5 searches the collection information DB 63d in the storage unit 63 for the collection information by using identification information such as the product code included in the received request as a query, and transmits the collection information to the recycler terminal 5 (Step S115).

Note that the recycler can efficiently collect the product by using information such as the attributes of the user of the collection product (age, date of birth, sex, residence, occupation, preference, and the like), the product identification information (for example, JAN code), the product name, the material information of the product or the component of the product, the number of products collected, the date and time when the product was placed at the collection place (the date and time when the product was inserted into the collection box), and the collection place (collection store), which are included in the received collection information.

After the recycler terminal 5 receives the collection information transmitted from the server 6 and the recycler (collector) collects the product based on the collection information, the controller 52 of the recycler terminal 5 transmits a request for the product information to the server 6 (Step S116).

The server 6 that has received the request for the product information from the recycler terminal 5 searches the product information DB 63b in the storage unit 63 for the product information by using identification information such as the product code included in the received request as a query, and transmits the product information to the recycler terminal 5 (Step S117).

Note that the recycler can efficiently recycle the product by using information such as information regarding product characteristics such as a product structure, a component removal method, a component replacement method, a product or component repair method, and a product instruction manual, which are included in the received product information.

After the recycler terminal 5 receives the product information transmitted from the server 6 and the recycler recycles the product based on the product information, the controller 52 of the recycler terminal 5 transmits recycling information to the server 6 (Step S118).

The server 6 that has received the recycling information from the recycler terminal 5 by the communication unit 61 stores the received recycling information in the recycling information DB 63e of the storage unit 63 (Step S119).

In the server 6, the statistical information generation unit 62f of the controller 62 generates statistical information regarding a statistic calculated by using the consumer information stored in the storage unit 63 and at least one of the product information, the sales information, the collection information, and the recycling information (Step S120).

As described above, according to the present embodiment, the information processing system 1 includes: the terminal device (manufacturer terminal 2) of a manufacturer that produces a product; the terminal device (distributor terminal 3) of a distributor who purchases the product from the manufacturer and sells the product; the terminal device (consumer terminal 4) of a consumer who purchases the product from the distributor and uses the product; the terminal device (recycler terminal 5) of a recycler who collects and recycles the used product from the consumer; and the server 6 accessible by each device. The information processing system 1 includes: the product information acquirer 62b that acquires product information of the product from the terminal device of the manufacturer; the sales information acquirer 62c that acquires sales information of the product from the terminal device of the distributor; the consumer information acquirer 62a that acquires consumer information from the terminal device of the consumer; the collection information acquirer 62d that acquires collection information of the product from the terminal device of the consumer; the recycling information acquirer 62e that acquires recycling information of the product from the terminal device of the recycler; and the statistical information generation unit 62f that generates statistical information regarding a statistic calculated by using the consumer information and at least one of the product information, the sales information, the collection information, and the recycling information. Thus, it is possible to generate information contributing to improvement in efficiency of product recycling in the circular economy by using a plurality of pieces of information including the consumer information.

Note that, in the above-described embodiment, the information processing system 1 may be provided with a display controller that displays information (traceability information) regarding traceability of a product or a component of the product on at least one display unit (output unit) of each terminal device (manufacturer terminal, distributor terminal, consumer terminal, or recycler terminal). As a result, the user (manufacturer, distributor, consumer, or recycler) of each terminal device can easily recognize when a product or the component of the product is produced, sold, collected, recycled, or resource-recycled by referring to the traceability information displayed on the display unit of each terminal device.

Some or all of the functional units described in the present specification may be realized by a program. The program referred to in the present specification may be distributed by being non-temporarily recorded in a computer-readable recording medium, may be distributed via a communication line (including wireless communication) such as the Internet, or may be distributed in a state of being installed on any terminal.

Based on the above description, a person skilled in the related art may be able to conceive additional effects and various modification examples of the present invention, but aspects of the present invention are not limited to the individual embodiment described above. Various additions, changes, and partial deletions can be made in a range without departing from the conceptual idea and spirit of the present invention derived from the contents defined in the claims and equivalents thereof.

For example, what has been described herein as one device (alternatively, member, the same applies below) (including what is depicted in the drawings as one device) may be realized by a plurality of devices. Conversely, what has been described herein as a plurality of devices (including what is depicted in the drawings as a plurality of devices) may be realized by one device. Alternatively, some or all of means or functions assumed to be included in a certain device (for example, a server) may be included in another device (for example, a user terminal).

In addition, not all the matters described in the present specification are essential requirements. In particular, matters described in the present specification and not described in the claims can be regarded as any additional matters.

Note that the applicant of the present invention is merely aware of the invention disclosed in the document in the column of “Citation List” in the present specification, and the present invention is not necessarily intended to solve the problem in the invention disclosed in the literature. The problem to be solved by the present invention should be recognized in consideration of the entire specification. For example, in the present specification, in a case where there is a description that a predetermined effect is exhibited by a specific configuration, it can be said that the problem of reversing the predetermined effect is solved. However, such a specific configuration is not necessarily an essential requirement.

1. An information processing system comprising:
a terminal device of a manufacturer that produces a product;
a terminal device of a distributor who purchases the product from the manufacturer and sells the product;
a terminal device of a consumer who purchases the product from the distributor and uses the product;
a terminal device of a recycler who collects and recycles the used product from the consumer;
and a server accessible by each device, wherein the information processing system includes
a product information acquirer that acquires product information of the product from the terminal device of the manufacturer,
a sales information acquirer that acquires sales information of the product from the terminal device of the distributor,
a consumer information acquirer that acquires consumer information from the terminal device of the consumer,
a collection information acquirer that acquires collection information of the product from the terminal device of the consumer,
a recycling information acquirer that acquires recycling information of the product from the terminal device of the recycler, and
a statistical information generation unit that generates statistical information regarding a statistic calculated by using the consumer information and at least one of the product information, the sales information, the collection information, and the recycling information.

2. The information processing system according to claim 1, wherein the consumer information includes information regarding at least one of an age, a sex, a residence, an occupation, a product collection history, and a preference of the consumer.

3. The information processing system according to claim 1, wherein the collection information includes information regarding a collection place of the product and information regarding a collection amount of the product for each collection place.

4. The information processing system according to claim 3, wherein the statistical information generation unit generates statistical information regarding a statistic obtained by aggregating the collection amount for each collection place, and
the information processing system further comprises an output unit that outputs information obtained by visualizing the statistical information generated by the statistical information generation unit.

5. The information processing system according to claim 3, wherein the product information includes first time information regarding a shipment date and time of the product,
the collection information includes second time information regarding a date and time when the product is placed at the collection place by the consumer, and
the statistical information generation unit generates statistical information regarding a difference between the first time information and the second time information for each collection place.

6. The information processing system according to claim 1, wherein the product information includes information regarding a production amount of the product,
the sales information includes information regarding a retail amount of the product, and
the statistical information generation unit generates statistical information regarding a statistic obtained by dividing the retail amount by the production amount.

7. The information processing system according to claim 1, wherein the product information includes information regarding a production amount of the product,
the collection information includes information regarding a collection amount of the product, and
the statistical information generation unit generates statistical information regarding a statistic obtained by dividing the collection amount by the production amount.

8. The information processing system according to claim 1, wherein the product information includes information regarding a production amount of the product,
the recycling information includes information regarding a recycling amount indicating an amount of the product recycled after collection, and
the statistical information generation unit generates statistical information regarding a statistic obtained by dividing the recycling amount by the production amount.

9. The information processing system according to claim 1, wherein the product information includes information regarding a production amount of the product,
the collection information includes information regarding a collection amount of the product,
the recycling information includes information regarding a resource-recycled amount indicating an amount resource-recycled among products recycled after collection, and
the statistical information generation unit generates statistical information regarding a statistic obtained by dividing the resource-recycled amount by the collection amount and further dividing the resource-recycled amount by the production amount.

10. The information processing system according to claim 1, wherein the product information includes information regarding a production amount of
the product and information regarding a wholesale amount of the product,
the sales information includes information regarding a retail amount of the product, the collection information includes information regarding a collection amount of the product,
the recycling information includes information regarding a recycling amount indicating an amount of the product recycled after collection, and
the statistical information generation unit generates statistical information regarding a statistic obtained by subtracting the wholesale amount, the retail amount, the collection amount, and the recycling amount from the production amount.

11. The information processing system according to claim 1, wherein the product information includes information regarding an amount of reduction in carbon dioxide emission per product reduced by recycling the product,
the recycling information includes information regarding a recycling amount indicating an amount of the product recycled after collection, and
the statistical information generation unit generates statistical information regarding a statistic obtained by multiplying the recycling amount by the amount of reduction in carbon dioxide emission per product.

12. The information processing system according to claim 1, further comprising:
a display controller that displays information regarding traceability of the product or a component of the product on a display unit of at least one device of the respective devices.

13. A method using an information processing system including a terminal device of a manufacturer that produces a product, a terminal device of a distributor who purchases the product from the manufacturer and sells the product, a terminal device of a consumer who purchases the product from the distributor and uses the product, a terminal device of a recycler who collects and recycles the used product from the consumer, and a server accessible by each device, the method comprising:
acquiring product information of the product from the terminal device of the manufacturer;
acquiring sales information of the product from the terminal device of the distributor;
acquiring consumer information from the terminal device of the consumer;
acquiring collection information of the product from the terminal device of the consumer;
acquiring recycling information of the product from the terminal device of the recycler; and
generating statistical information regarding a statistic calculated by using the consumer information and at least one of the product information, the sales information, the collection information, and the recycling information.

14. (canceled)

15. A non-transitory computer-readable storage medium storing a program for causing a computer to execute the method according to claim 13.

16. An information processing device comprising:
a product information acquirer that acquires product information of a product from a terminal device of a manufacturer that produces the product;
a sales information acquirer that acquires sales information of the product from a terminal device of a distributor who purchases the product from the manufacturer and sells the product;
a consumer information acquirer that acquires consumer information from a terminal device of a consumer who purchases the product from the distributor and uses the product;
a collection information acquirer that acquires collection information of the product from the terminal device of the consumer;
a recycling information acquirer that acquires recycling information of the product from a terminal device of a recycler who collects the used product from the consumer and recycles the product; and
a statistical information generation unit that generates statistical information regarding a statistic calculated by using the consumer information and at least one of the product information, the sales information, the collection information, and the recycling information.
